(19) United States
(12) Patent Application Publication
(10) Pub. No.: US 2012/0124631 A1
(43) Pub. Date: May 17, 2012

(54) Content upload method and content delivery function entity

(75) Inventor: Hongfei Xia, Shenzhen (CN)

(73) Assignee: ZTE CORPORATION, Shenzhen, Guangdong (CN)

(21) Appl. No.: 13/257,841

(22) PCT Filed: Dec. 21, 2009
(86) PCT No.: PCT/CN09/75788

§ 371 Date: Jan. 20, 2012

(30) Foreign Application Priority Data
Aug. 6, 2009 (CN) 200910164196.7

(51) Int. Cl. H04N 21/63; H04N 21/643

(52) U.S. Cl. 725/109

(57) ABSTRACT

The present disclosure discloses a method for uplinking contents and a content delivery function entity. The method is used for uploading the contents or uplinking a media stream generated by a UE to one or more CDN nodes of CDN, and comprises the following steps: after receiving a session initiation request for uploading contents or uplinking a media stream, allocating by a CDN control function entity one or more CDN nodes, and sending a session request to a cluster control function entity of the CDN node; selecting, by the cluster control function entity which receives the session request, a content delivery function entity, establishing a session for uploading the contents or uplinking the media stream between itself and the selected content delivery function entity, and returning session acknowledgement information to the CDN control function entity; and returning, by the CDN control function entity, the received acknowledgement information to a user equipment; uploading the contents or uplinking the media stream according to the acknowledgement information by the user equipment to each content delivery function entity selected by the cluster control function entity. According to the present disclosure, the content delivery network in the next generation network can support user-generated contents.

### TECHNICAL FIELD

The present disclosure relates to the field of mobile communications, in particular to a method for uplinking contents and a content delivery function entity.

### BACKGROUND

An interactive network television, also called an Internet Protocol TeleVision (IPTV), is a generic term for equipment providing services to users through an IP bearer network, such as live broadcasting, program on demand and time-shifted broadcasting of television programs supporting interaction capability. With the development of the IPTV, the number of its user is increased continuously, thus it presents a higher requirement on system performance and reliability, etc. For the content delivery function of the interactive network, in order to decrease the interaction among different parts of a system, it is required that the internal modules of a content interactive network are endowed with clear functions and responsibilities, and the content delivery and service process are brief and reliable.

At present, the IPTV standard is dominated by two architectures: IP Multimedia Subsystem (IMS) of a Next Generation Network (NGN) and non-IMS of the NGN, which can provide program on demand, live broadcasting, video recording, and some new services for the users.

Content Delivery Network (CDN) in the IPTV architecture plays an important role in the guarantee of quality of experience (QoE) and system stability in the IPTV system. Each important function entity in the CDN is mainly used to realize the functions of content location technology, scheduling and storage.

Currently, only the services of content provided by the service provider to the users are involved in the content delivery network, rather than services needing to be uploaded in real time such as user-generated contents. These services need the guarantee of QoS (quality of service)/QoE as well. However, in the current CDN, the guarantee of the QoS/QoE has not been provided to content uploading/upstreaming based on the user-generated contents.

### SUMMARY

In view of this, the present disclosure provides a method for uplinking contents and a content delivery function entity, so as to solve the problem that the content delivery network in the next generation network does not support the QoS of user-generated contents in the prior art.

According to one aspect of the present disclosure, the present disclosure provides a method for uplinking contents, which is used for uploading contents or uplinking a media stream generated by a user equipment (UE) to one or more CDN nodes of the CDN.

According to the present disclosure, the method for uplinking contents comprises the following steps: after receiving a session initiation request for uploading contents or uplinking a media stream, allocating by a CDN control function entity one or more CDN nodes, and sending a session request to a cluster control function entity of the CDN node; selecting, by the cluster control function entity which receives the session request, a content delivery function entity, establishing a session for uploading the contents or uplinking the media stream between itself and the selected content delivery function entity, and returning session acknowledgement information to the CDN control function entity; and returning, by the CDN control function entity, the received acknowledgement information to a user equipment; uploading the contents or uplinking the media stream according to the acknowledgement information by the user equipment to each content delivery function entity selected by the cluster control function entity.

According to the present disclosure, it also provides a content delivery network.

The content delivery network, according to the present disclosure, comprises a CDN control function entity and one or more CDN nodes. The CDN control function entity comprises a first receiving module, a first selecting module and a first transmitting module. The first receiving module is used for receiving a session initiation request from the user equipment for uploading contents or uplinking a media stream; the first selecting module is used for allocating one or more CDN nodes according to load information of one or more CDN nodes and/or region information contained in the session initiation request; the first transmitting module is used for sending a session request to a cluster control function entity of the CDN node allocated by the first selecting module. Each CDN node comprises a cluster control function entity and at least a content delivery function entity. The cluster control function entity comprises a second receiving module, a second selecting module, a session establishing module and a second transmitting module. The second receiving module is used for receiving the session request sent by the CDN control function entity; the second selecting module is used for selecting a content delivery function entity according to load status information of each content delivery function entity in the CDN node where the cluster control function entity locates; the session establishing module is used for establishing a session between the cluster control function entity and the content delivery function entity selected by the second selecting module; the second transmitting module is used for sending attribute information of the session established by the session establishing module to the user equipment. The content delivery functiona entity is used for receiving a media file uploaded or a media stream uplinked by the user equipment.

Through at least one of the above technical solutions of the present disclosure, by means of that the CDN control function entity selects a CDN node for saving the contents uplinked by user equipment, and by means of establishing a session for uploading the contents or uplinking the media stream between the cluster control function entity and the content delivery function entity inside the CDN node, user-equipment-generated contents can be uploaded or user-equipment-generated media stream can be uplinked to the content delivery function entity of the CDN node, so that the content delivery network in the next generation network can support user-generated contents.

Additional features and advantages of the present disclosure will be set forth in the description which follows, and in part will be apparent from the description, or may be learned by practice of the present disclosure. The purposes and additional advantages of the present disclosure can be realized and acquired through the written description, claims and structure specifically indicated in the figures.

### BRIEF DESCRIPTION OF THE DRAWINGS

FIG. 1 is a diagram illustrating a structure of an NGN-based IPTV system according to an embodiment of the present disclosure;

FIG. 2 is a flowchart illustrating a method for uploading contents according to an embodiment of the present disclosure;

FIG. 3 is a flowchart illustrating Embodiment One;

FIG. 4 is a flowchart illustrating Embodiment Two; and

FIG. 5 is a diagram illustrating a structure of a content delivery network according to an embodiment of the present disclosure.

### DETAILED DESCRIPTION

Since only QoS/QoE of service of contents provided by the service provider to the users is involved in the current content delivery network, rather than QoS/QoE of services needing to be uploaded in real time such as user-generated contents, while these services need QoS/QoE guarantee as well, the embodiment of the present disclosure therefore provides a technical solution capable of supporting user-generated content uploading. In the embodiment of the present disclosure, when needing to uplink contents, a user equipment sends a session request to a CDN control function entity through the IPTV service control function entity and/or service control function entity, so as to request for uploading the contents or uplinking a media stream. After receiving the session request, the CDN control function entity selects one or more CDN nodes to save the contents to be uploaded by the user equipment, and then sends the session request to a cluster control function entity of the selected one or more CDN nodes; the cluster control function entity which has received the session request selects a content delivery function entity of the CDN node where the cluster control function entity locates, and establishes a session for the contents uploaded or upstreamed by the user equipment between the cluster control function entity and the content delivery function entity. The user equipment uploads or upstreams the contents generated by it to the content delivery function entity through the session.

In the embodiment of the present disclosure, upstreaming is also called media stream. Uplinking means that the user equipment streams the contents to get a code stream and sends it to a content delivery function entity for caching or storing. Uploading the contents refers to uploading a media file to the content delivery function entity from the user equipment.

In the condition of no conflict, the embodiments and features in the present disclosure can be combined mutually.

The preferred embodiments of the present disclosure will be described hereinafter, with reference to the figures; it shall be understood that the preferred embodiments described here aim only to describe and explain the present disclosure, but not limit the present disclosure.

In order to well understand the technical solution provided by the embodiment of the present disclosure, an NGN-based IPTV system applied in the embodiment of the present disclosure will be introduced prior to the description of the technical solution.

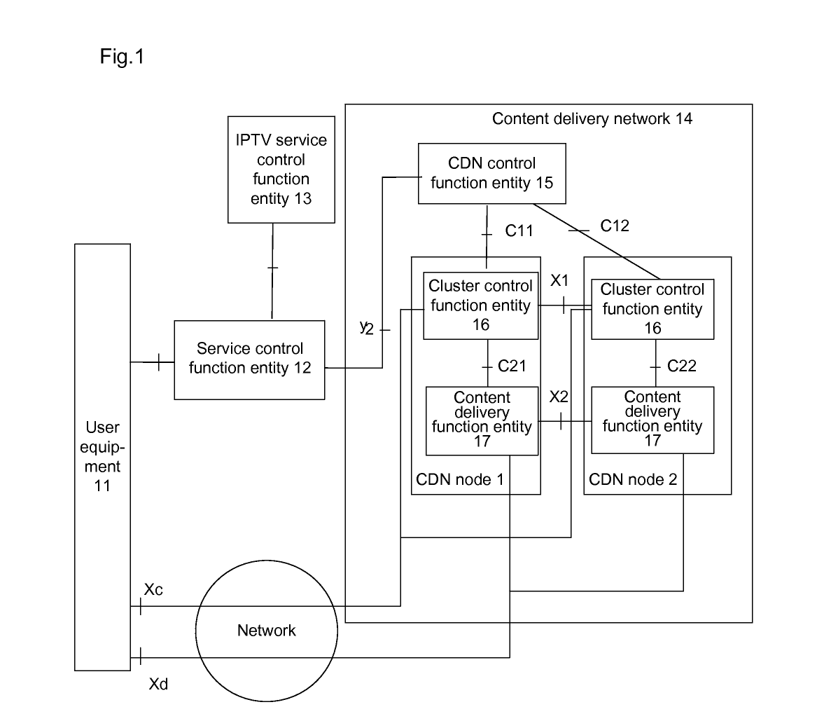

FIG. 1 is a diagram illustrating a structure of an NGN-based IPTV system according to an embodiment of the present disclosure. As shown in FIG. 1, the NGN-based IPTV system mainly comprises: a User Equipment (UE) 11, named as end-user function in ITU Telecommunication Standardization Sector (ITU-T); a Service Control Function entity (SCF) 12, being the core IMS in the NGN; an IPTV Service Control Function entity (IPTV SCF) 13, sometimes also named as IPTV Application Function entity (IPTVAF); a Content Delivery Network (CDN) 14, sometimes also named as content delivery and storage in the NGN. The CDN 14 may further comprise: a CDN (main) controller or a CDN control function entity (Content Delivery & Storage Control Functions/Content Delivery Network Control Functions/Content Distribution & Location Control Functions, CD&SCF/CDNCF/CD&LCF) 15, a Cluster Control Function entity (or Content Distribution & Delivery & Location control functions, CCF or CD&D&LCF for short) 16, and a Content Delivery Function entity (or Content Delivery and Storage Function, CDF or CD&SF) 17. A CDN node (1, 2 . . . n) can comprises a cluster control function entity 16 and one or more content delivery function entities 17. In the specific application, the CDN node (called cluster as well) is not limited to CDN node 1 and CDN node 2 (as shown in the figure) but can be more nodes.

Each entity and each interface of the NGN-based IPTV system will be respectively described hereinafter.

UE 11, specifically, may be a mobile phone with mobile capability, a set top box of a fixed network, or a soft terminal realized on the basis of software for realizing the function of a set top box, and also comprises function entities such as a home gateway. The UE can realize IPTV services such as program on demand and live broadcasting through information interaction with the user.

SCF 12 is connected with UE 11 and mainly used for session control, service certification, authentication and charging as the aggregate of the main function entities of NGN service control layer. In the case of IMS network, the function entity is the core IMS. The core IMS is mainly used for providing an SIP-based session control mechanism, performing certification and authentication to an IPTV terminal user and requesting a resource and admission control subsystem to conduct resource allocation. The core IMS completes functions such as security, QoS, charging and roaming through interaction of SIP session with the IPTV terminal, IPTV application function entity and content delivery function entity.

IPTV SCF 13 is connected with SCF 12 through a Session Initiation Protocol (SIP), and is used for providing service authentication at the time of session initiation or modification. IPTV SCF 13 is provided with the following functions: checking user information and checking whether the user uses the selected contents legally; restricting and controlling the credit; selecting for the system an IPTV cluster control function entity 16 providing preliminary services; wherein the IPTV cluster control function entity mainly aims at IPTV services such as program on demand, live broadcasting, video recording and time-shifted broadcasting. IPTV SCF 13 is an IPTV SIP application server in the case of IMS network, corresponds to the aggregate of IPTV control and IPTV application in the Open IPTV Forum, or corresponds to IPTV application functions, application support functions and service support functions in the ITU-T.

CDN 14 is connected with the UE through interfaces Xc and Xd; wherein CDN 14 is connected with the UE through interface Xc to control the media stream according to the Real Time Streaming Protocol (RTSP), CDN 14 is connected with the UE through interface Xd to perform transmission and media downloading to the media stream RTP (via HyperText Transfer Protocol (HTTP)).

The CDN control function entity 15 completes the selection of the cluster control function entity 16. Generally, a CDN network is possibly provided with one or more CDN control function entities, among which the interaction is required to complete the selection of the cluster control function entity 16. The CDN control function entity 15 comprises location control functions and distribution control functions. The location control functions are responsible for locating the requested contents to a proper CDN node, and the distribution control functions are responsible for controlling content distribution (content injection, content scheduling and aging, etc.).

The cluster control function entity 16 represents UE to perform the message interaction with the content delivery function entity 17, maintains the status of the content delivery function entity 17 and processes the interaction with the content delivery function entity 17, and terminates the establishment of IPTV service session. The cluster control function entity 16 comprises location control functions, distribution control functions and content delivery functions. The location control functions are responsible for locating the requested contents to a proper content delivery function entity 17, and the distribution control functions are responsible for controlling content distribution (content injection, content scheduling and aging, etc.) to specific content delivery function entity 17. Content delivery functions are mainly responsible for controlling RTSP media stream.

The content delivery function entity 17 is responsible for media processing and delivery (unicast or multicast), and the content delivery and storage.

Interface C21/C22 (RTSP interface), through which the user cluster control function entity 16 performs media control to the content delivery function entity 17.

Interface C11/C12 (control interface) is realized through the SIP protocol, and the CDN control function entity 15 decides information of other CDN nodes capable of is providing content uploading service; a CDN nodes can also report its service status information to the CDN control function entity 15 through this interface.

According to an embodiment of the present disclosure, the present disclosure firstly provides a method for uploading contents. The method is used for uploading user-equipment-generated contents to one or more CDN nodes of the content delivery network, or used for uplinking user-equipment-generated media stream to one or more CDN nodes of the content delivery network.

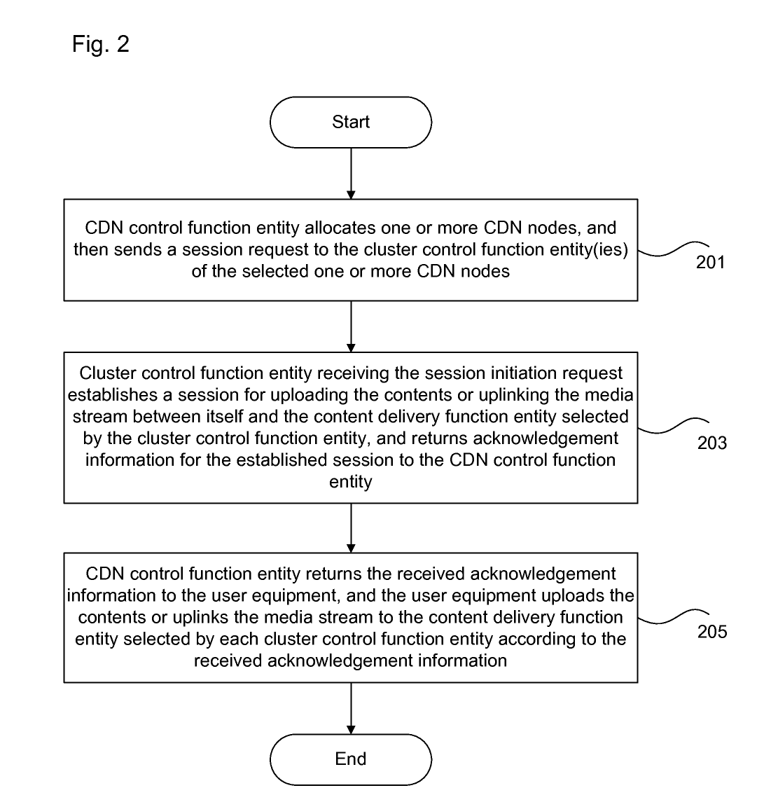

FIG. 2 is a flowchart illustrating a method for uplinking contents according to an embodiment of the present disclosure. As shown in FIG. 2, the method for uploading contents according to the embodiment of the present disclosure, mainly comprises the following steps (step S201-step S205):

step S201: after receiving a session initiation request for requesting to upload contents or uplink a media stream, the CDN control function entity allocates one or more CDN nodes, and then sends the session request to the cluster control function entity(ies) of the selected one or more CDN nodes;

step S203: the cluster control function entity receiving the session initiation request establishes a session for uploading the contents or uplinking the media stream between itself and the content delivery function entity selected by the cluster control function entity, and returns acknowledgement information for the established session to the CDN control function entity;

step S205: the CDN control function entity returns the received acknowledgement information to the user equipment, and the user equipment uploads the contents or uplinks the media stream to the content delivery function entity selected by each cluster control function entity according to the received acknowledgement information.

In the embodiment of the present disclosure, the session initiation request sent by the user equipment includes: a session initiation request for requesting to upload the contents (i.e. upload a media file) and a session initiation request for requesting to uplink the media stream (i.e. upstreaming, the UE sends the media stream to the CDN in an RTSP way). For the uplinking of these different contents, the embodiments of the present disclosure respectively provide specific technical solutions, which will be explained through specific embodiments hereinafter.

### Embodiment One

In this embodiment, the user equipment requests for uploading a media file, which can be realized in a way of FTP (File Transfer Protocol)/HTTP. In this embodiment, the cluster control function entity returns path information of the content delivery function entity which is used for saving the media file uploaded by the user equipment to the CDN control function entity, specifically, the path information may include: an IP address and port information of the content delivery function entity.

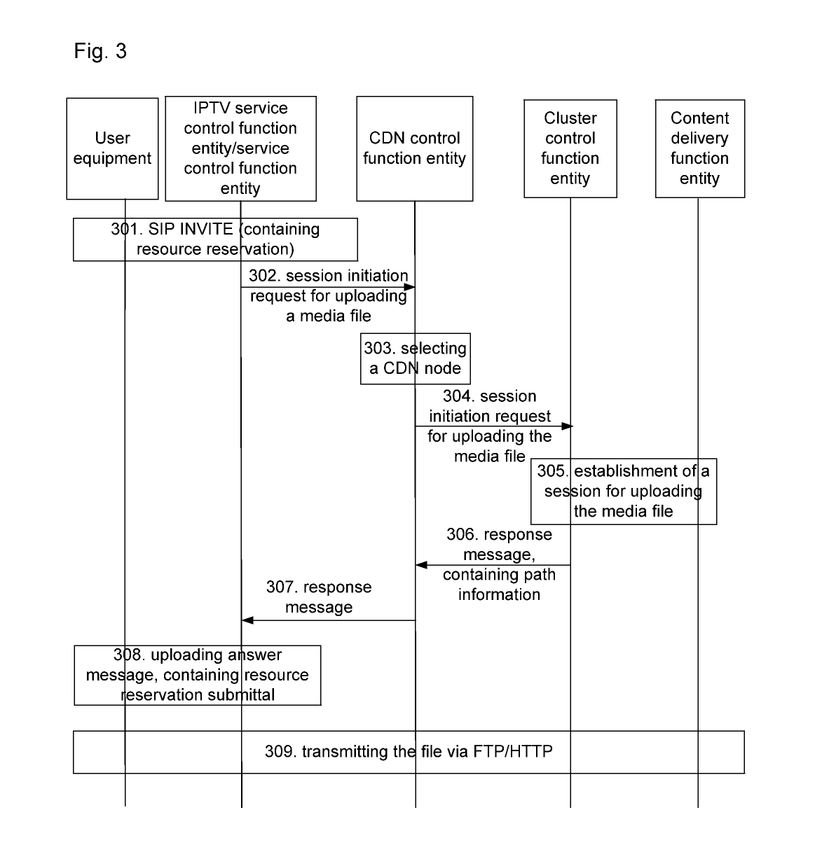

FIG. 3 is a flowchart illustrating the upload of the media file by the user equipment according to the embodiment. As shown in FIG. 3, the upload flow of the media file by the user equipment mainly comprises the following steps:

Step 301, the user equipment sends a session request (SIP INVITE) for uploading a media file upload to the service control function entity and/or IPTV service control function entity.

In the specific implementation process, the UE may upload the media file via FTP/HTTP, etc.

Specifically, during the process of implementing this step, the interaction among the UE, the IPTV service control function entity, the service control function entity, and the Resource and Admission Control Function entity (RACS or RACF) will be involved, wherein resource reservation operation will be involved between the service control function entity and the resource and admission control function entity.

Specifically, the session request may contain one or any combination of the following information items: identifier information of the uploaded contents, content description information and the size information of the media file, etc. Besides, in the condition that the core IMS conducts core controlling, the session request may adopt Session Initiation Protocol (SIP) to save the related information in Session Description Protocol (SDP) for sending.

Step 302, the IPTV service control function entity or service control function entity sends the session initiation request for uploading the media file to the CDN control function entity in the CDN.

In the specific implementation process, the session initiation request may contain information of a specific region to indicate the CDN control function entity to select CDN nodes in the specific region; or the session initiation request does not contain information of a specific region, i.e., not restricting the range of CDN nodes selected by the CDN control function entity.

Step 303, the CDN control function entity receiving the session initiation request for uploading the media file determines one or more CDN nodes for saving the media file (or called media contents) according to the load information of the CDN nodes managed by it and the condition whether the received session initiation request contains information on a specific region.

In this embodiment, the description will be made by taking CDN node 1 as an example. For the selection of more CDN nodes, the specific operation is similar to that for the selection of one CDN node.

Step 304, the CDN control function entity forwards the session initiation request for uploading the media file to the cluster control function entity of CDN node 1 selected by the CDN control function entity.

Step 305, the cluster control function entity selects a content delivery function entity of the CDN node where the cluster control function entity locates and establishes a session for uploading media file between itself and the content delivery function entity.

Specifically, the cluster control function entity may make selection of content delivery function entity according to the load condition of a content delivery function entity.

Specifically, the establishment of the session for uploading the media file between the cluster control function entity and the content delivery function entity may comprise the following steps:

step 1, the cluster control function entity sends a content uploading request to the content delivery function entity selected by it;

step 2, the content delivery function entity receives the content uploading request and sends a response message for content uploading to the cluster control function entity; wherein the response message contains acknowledgement information for uploading and path information through which the media file can be saved;

step 3, the cluster control function entity determines the information of resources required for uploading the media file according to the size of the media file contained in the session initiation request from the CDN control function entity, wherein the information of resources contains information on bandwidth required to be allocated.

In the specific implementation process, step 3 may be implemented in priority to step 1 and step 2.

Step 306, the cluster control function entity sends a response message to the CDN control function entity, the response message contains the path information about the content delivery function entity which is used for saving the media file uploaded by the user equipment, namely, the IP address and port, etc.; optionally, the response message may also contain the information on the bandwidth required for uploading the media file.

Step 307, the CDN control function entity forwards the information contained in the received response message to the IPTV service control function entity or service control function entity through a response message for media file uploading;

Step 308, the IPTV service control function entity or service control function entity returns that information to the UE through an uploading answer message. The implementation of operation of step 308 includes the operation of submitting resources such as bandwidth reserved by the service control function entity in step 301.

Step 309, the UE receiving the uploading answer message performs file transmission between itself and the corresponding content delivery function entity through FTP or HTTP according to the IP address and port information, etc., and uploads the media contents of the UE to the content delivery function entity.

### Embodiment Two

In this embodiment, the user equipment request for uplinking a media stream. In this embodiment, the cluster control function entity returns RTSP session identifier information to the CDN control function entity.

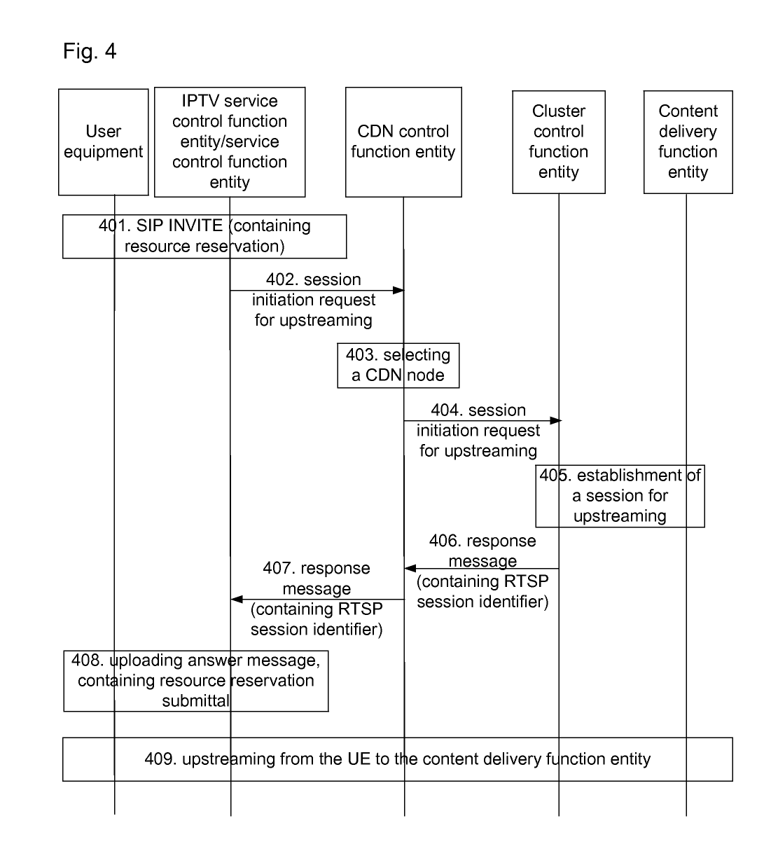

FIG. 4 is a flowchart illustrating the upstreaming (i.e., media stream uplinking) of the user equipment. As shown in FIG. 4, the upstreaming flow of the user equipment mainly comprises the following steps:

Step 401, the UE sends a session request (SIP INVITE) for upstreaming to the IPTV service control function entity/service control function entity.

The interaction among the UE, the IPTV service control function entity, the service control function entity, and the Resource and Admission Control Function entity (RACS or RACF) will be involved in this session request, wherein resource reservation operation will be involved between the service control function entity and the resource and admission control function entity.

Specifically, the session request may contain content identifier information of the upstreaming, content description information, and the size information of the code stream of the media contents, etc. In the condition that the core IMS conducts core controlling, the session request may adopt SIP to save the related information in SDP for sending.

Step 402, the IPTV service control function entity or service control function entity sends the session initiation request for upstreaming to the CDN control function entity.

Step 403, the CDN control function entity receiving the session initiation request for upstreaming determines one or more CDN nodes for saving the media stream uploaded by the UE according to the load information of the CDN nodes managed by it and the condition whether the requested SDP contains information on a specific region. In this embodiment, the description will be made by taking a selected CDN node as an example. For other selected CDN nodes, the operation is similar.

Step 404, the CDN control function entity forwards the session initiation request for upstreaming to the cluster control function entity of the CDN node selected by the CDN control function entity.

Step 405, the cluster control function entity selects a content delivery function entity, for example, according to the information on the load status of a content delivery function entity, and establishes a session for upstreaming between itself and the content delivery function entity.

Specifically, the establishment of the session between the cluster control function entity and content delivery function entity may comprise the following steps:

step 1, the cluster control function entity sends an upstreaming inquiry request (RTSP DESCRIBE message) to the content delivery function entity selected by it;

step 2, the content delivery function entity returns a response message to the cluster control function entity, wherein the response message may contain information on a media path through which the upstreaming is received, namely, the IP address and port information, etc.;

step 3, the cluster control function entity sends a media path setup message (RTSP SETUP) to the content delivery function entity;

step 4, the content delivery function entity receives the media path setup message and sends an acknowledgement message indicating a success of the media path setup to the cluster control function entity; the acknowledgement message contains RTSP session identifier information, i.e., RTSP Session ID;

step 5, the cluster control function entity determines the information of resources allocated for the upstreaming according to the information such as the size of code stream (for example, high definition and standard definition, etc.) contained in the received session initiation request for upstreaming, wherein the information of resources contains information on bandwidth required to be allocated, etc.

In the specific implementation process, step 5 may be implemented in priority to step 1, 2. 3 and 4.

Step 406, the cluster control function entity sends a response message to the CDN control function entity, and the response message contains the session identifier information of the set-up RTSP and resource information such as the bandwidth.

Step 407, the CDN control function entity forwards the information contained in the received response message to the IPTV service control function entity or service control function entity.

Step 408, the IPTV service control function entity or service control function entity returns the information received in step 407 to the UE, specifically it is returned to the UE through an upstreaming answer message.

The implementation of this step includes the operation of submitting resources such as bandwidth reserved by the service control function entity in step 401.

Step 409, upstreaming is uplinked from the UE to the content delivery function entity.

Specifically, the UE receiving the response message conducts the following steps according to the information contained in the message:

step 1, the UE sends an RTSP record request to the cluster control function entity to request for recording contents; the request contains the received RTSP session identifier;

step 2, the cluster control function entity requests the content delivery function entity for RTSP RECORD to request for recording contents;

step 3, the content delivery function entity sends an acknowledgement message to the cluster control function entity, namely, recording will be performed;

step 4, the cluster delivery function entity sends an acknowledgement message to the UE, namely, recording will be performed, and the upstreaming will be uplinked from the UE to the content delivery function entity.

Through the above method for uploading the contents provided by the embodiments of the present disclosure, the uploading of user-generated contents can be realized.

According to an embodiment of the present disclosure, the present disclosure also provides a content delivery network.

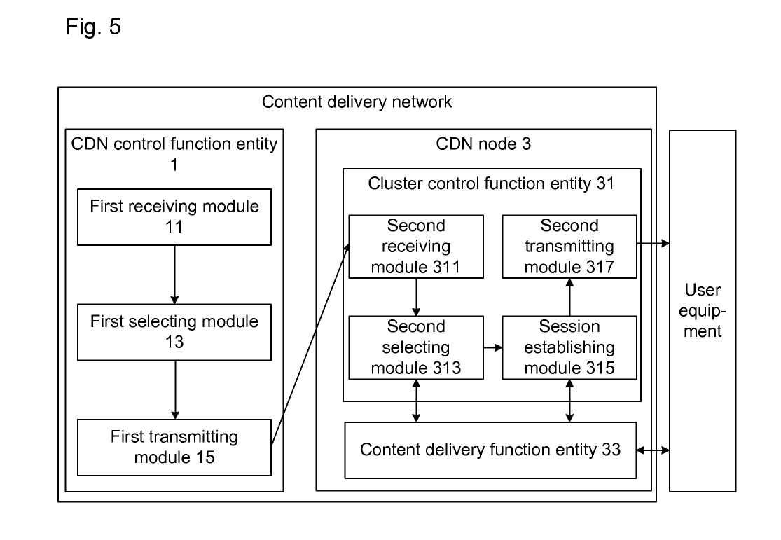

FIG. 5 is a diagram illustrating a structure of a content delivery network according to an embodiment of the present disclosure. As shown in FIG. 5, the content delivery network according to the embodiment of the present disclosure mainly comprises: a CDN control function entity 1 and one or more CDN nodes 3 (one CDN node is shown in the figure).

The above function entities will be described respectively hereinafter with reference to the attached figure.

As shown in FIG. 5, specifically, the CDN control function entity can comprises: a first receiving module 11, a first selecting module 13 and a first transmitting module 15. The first receiving module 11 is used for receiving a session initiation request for uploading contents or uplinking a media stream; the first selecting module 13 is connected with the first receiving module 11 and is used for allocating one or more CDN nodes according to load information of one or more CDN nodes 3 and/or region information contained in the session initiation request; the first transmitting module 15 is connected with the first receiving module 11 and is used for sending a session request to a cluster control function entity(ies) of one or more the CDN nodes allocated by the first selecting module 11.

Each CDN node 3 comprises: a cluster control function entity 31 and at least one content delivery function entity 33 (only one is shown in the figure for description convenience).

As shown in FIG. 5, the cluster control function entity 31 comprises: a second receiving module 311, a second selecting module 313, a session establishing module 315 and a second transmitting module 317. The second receiving module 311 is used for receiving the session request sent by the CDN control function entity 1; the second selecting module 313 is connected with the second receiving module 311 and is used for selecting a content delivery function entity according to the load status information of each content delivery function entity 33 in the CDN node where the cluster control function entity locates; the session establishing module 315 is connected with the second selecting module 313 and is used for establishing a session between the cluster control function entity and the content delivery function entity 33 selected by the second selecting module 313; the second transmitting module 317 is connected with the session establishing module 315 and is used for sending acknowledgement information that the session is established by the session establishing module 317 to the user equipment.

The content delivery function entity 33 is connected with the cluster control function entity 31 and user equipment, and is used for receiving the contents uploaded or the media stream uplinked by the user equipment.

As mentioned above, in virtue of the technical solution provided by the embodiments of the present disclosure, by means of that the CDN control function entity selects a CDN node for saving the data uploaded by the user equipment, and by means of establishing a session for uploading the data between a cluster control function entity and a content delivery function entity inside the CDN node, the user-equipment-generated contents can be uploaded to the content delivery function entity of the CDN node, so that the content delivery network in the next generation network can support user-generated contents, thus providing more new services for the users, improving the user experience and enhancing the competitiveness of the service provider.

The above description is only preferred embodiments of the present disclosure and is not used for restricting the present disclosure; for those skilled in the art, various modifications and changes can be made to the present disclosure. Any modifications, equivalent replacements and improvements, etc. within the principle of the present disclosure shall be included within the protection scope of the present disclosure.

1. A method for uplinking contents, comprising:
after receiving a session initiation request for uploading contents or uplinking a media stream, allocating by a Content Delivery Network (CDN) control function entity one or more CDN nodes, and sending a session request to a cluster control function entity of the CDN node;
selecting, by the cluster control function entity which receives the session request, a content delivery function entity, establishing a session for uploading the contents or uplinking the media stream between itself and the selected content delivery function entity, and returning session acknowledgement information to the CDN control function entity; and
returning, by the CDN control function entity, the received acknowledgement information to a user equipment; uploading the contents or uplinking the media stream according to the acknowledgement information by the user equipment to each content delivery function entity selected by the cluster control function entity.

2. The method according to claim 1, further comprising: before the CDN control function entity receives the session initiation request,
sending by the user equipment a request message to a service control function entity or an IPTV service control function entity, so as to request to upload the contents or uplinking the media stream to the CDN;
sending, by the service control function entity or the IPTV service control function entity, the session initiation request to the CDN control function entity after receiving the request message.

3. The method according to claim 2, wherein the request message and the session initiation request each include one or any combination of the following items: content identifier information of the uploaded contents or the uplinked media stream, content description information, and size information of a code stream of the contents.

4. The method according to claim 1, wherein the CDN control function entity allocates one or more CDN nodes in the following way:
determining, by the CDN control function entity, one or more CDN nodes required to save the contents of the user equipment according to load information of each CDN node managed by the CDN control function entity and/or region information contained in the session initiation request.

5. The method according to claim 1, wherein the cluster control function entity selects a content delivery function entity according to load status information of each content delivery function entity in the CDN node where the cluster control function entity locates.

6. The method according to claim 1, wherein the operation of returning by the CDN control function entity the received acknowledgement information to the user equipment comprises:
sending, by the CDN control function entity, the acknowledgement information to an IPTV service control function entity or a service control function entity; and
sending, by the IPTV service control function entity or the service control function entity, the acknowledgement information to the user equipment.

7. The method according to claim 1, wherein when the session initiation request received by the CDN control function entity is a request for uploading the contents, the contents requested to be uploaded by the user equipment includes a media file, the acknowledgement information includes path information of the content delivery function entity which is used for saving the media file, wherein the path information includes an IP address and port information.

8. The method according to claim 7, wherein the operation that the cluster control function entity establishes the session for uploading the contents or uplinking the media stream between itself and the content delivery function entity selected by it comprises:
sending, by the cluster control function entity, a content uploading request to the content delivery function entity; and
receiving, by the content delivery function entity, the content uploading request, and sending a response message for content uploading to the cluster control function entity; wherein the response message contains acknowledgement information for content uploading and information on a path through which the media file can be saved.

9. The method according to claim 8, wherein the operation that the cluster control function entity establishes the session for uploading the contents or uplinking the media stream between itself and the content delivery function entity selected by it further comprises:
determining, by the cluster control function entity, resources allocated for uploading the media file according to a size of the media file contained in the received session initiation request which is uploaded by the user equipment.

10. The method according to claim 9, wherein the operation that the user equipment uploads the contents to each content delivery function entity according to the acknowledgement information comprises:
performing, by the user equipment, file transmission between itself and each content delivery function entity respectively according to the path information, to upload the media contents in the user equipment to each content delivery function entity.

11. The method according to claim 1, wherein the session initiation request received by the CDN control function entity is a request for uplinking the media stream, the contents of the media stream requested to be uplinked by the user equipment includes streamed media, the acknowledgement information includes a session identifier of a set-up RTSP.

12. The method according to claim 11, wherein the operation that the cluster control function entity establishes the session for uploading the contents or uplinking the media stream between itself and the content delivery function entity selected by it comprises:
sending, by the cluster control function entity, an inquiry request for media stream uplinking to the content delivery function entity;
receiving, by the content delivery function entity, the inquiry request, and sending a response message to the cluster control function entity, wherein the response message contains information on a media path through which the streamed media is received;
receiving, by the cluster control function entity, the response message, and sending a media path setup request to the content delivery function entity; and
receiving, by the content delivery function entity, the media path setup request and returns an acknowledgement message indicating a success of the media path setup to the cluster control function entity; wherein the acknowledgement message contains the RTSP session identifier.

13. The method according to claim 12, wherein the operation that the cluster control function entity establishes the session for uploading the contents or uplinking the media stream between itself and the content delivery function entity selected by it further comprises:
determining, by the cluster control function entity, resources allocated to uplink the media stream according to size information of a code stream of the uplinked media stream contained in the session initiation request.

14. The method according to claim 13, wherein the operation that the user equipment uploads the contents to each content delivery function entity according to the acknowledgement information comprises:
sending, by the user equipment, an RTSP request to the cluster control function entity according to the RTSP session identifier returned by the cluster control function entity, wherein the RTSP request contains the RTSP session identifier;
receiving, by the cluster control function entity, the RTSP request, and sending a stream control request to the content delivery function entity selected by the cluster control function entity;
sending, by the content delivery function entity, an acknowledgement message to the cluster control function entity; and
returning, by the cluster control function entity, the acknowledgement message to the user equipment; and uplinking by the user equipment the streamed media.

15. A content delivery network, comprising: a CDN control function entity and one or more CDN nodes; wherein
the CDN control function entity comprises:
a first receiving module, used for receiving a session initiation request for uploading contents or uplinking a media stream;
a first selecting module, used for allocating one or more CDN nodes according to load information of one or more CDN nodes and/or region information contained in the session initiation request;
a first transmitting module, used for sending a session request to a cluster control function entity of the CDN node allocated by the first selecting module; and
each CDN node comprises a cluster control function entity and at least one content delivery function entity, wherein
the cluster control function entity comprises:
a second receiving module, used for receiving the session request sent by the CDN control function entity;
a second selecting module, used for selecting a content delivery function entity according to load status information of each content delivery function entity in the CDN node where the cluster control function entity locates;
a session establishing module, used for establishing a session between the cluster control function entity and the content delivery function entity selected by the second selecting module;
a second transmitting module, used for sending attribute information of the session established by the session establishing module to a user equipment;
the content delivery function entity is used for receiving a media file uploaded or a media stream uplinked by the user equipment.
